(19) United States
(12) Patent Application Publication
(10) Pub. No.: US 2001/0053740 A1
(43) Pub. Date: Dec. 20, 2001

(54) Bismuth lanthanum titanate (BLT), BLT thin film, and electronic device including the BLT thin film

(76) Inventor: Chang-Jung Kim, Seongnam-city (KR)

Correspondence Address: The Law Offices of Eugene M Lee, PLLC, Suite 1200, 2111 Wilson Boulevard, Arlington, VA, 22201, US

(21) Appl. No.: 09/873,289

(22) Filed: Jun. 5, 2001

(30) Foreign Application Priority Data
Jun. 5, 2000 (KR) 00-30796

(51) Int. Cl. C04B 35/46; B05D 3/02

(52) U.S. Cl. 501/134; 501/152; 427/376.2

(57) ABSTRACT

Bismuth lanthanum titanate (BLT) having a formula Bi₄₋ₓLaₓTi₃O₁₂, a method for preparing the BLT, a BLT thin film formed of the BLT, a method for forming the BLT thin film, and an electronic device including the BLT thin film, where 0<x≦2.

### BACKGROUND OF THE INVENTION

1. Field of the Invention

The present invention relates to bismuth lanthanum titanate (BLT), a BLT thin film, and an electronic device employing the BLT film, and more particularly, to BLT having a ferroelectric characteristic, a BLT thin film, and an electronic device whose fatigue characteristic is improved by adopting the BLT thin film.

2. Description of the Related Art

With the advance of portable information communications device, the demand for non-volatile memory device capable of retaining information stored therein even when power is turned off is increasing. A ferroelectric RAM (FeRAM) as an electronic device which satisfies the demand has advantages in terms of rapid information writing speed and low power consumption.

In the manufacture of the FeRAM, a capacitor is manufactured by forming upper and lower electrodes on both sides of a ferroelectric thin film. A PZT(PbZr_{X}Ti_{1-X}O₃) (where 0≦X<1) film or SBT(SrBi₂Ta₂O₉) film is used as the ferroelectric thin film. The fatigue characteristic of the FeRAM is poor when the ferroelectric thin film is formed of the PZT film. To solve this problem, as the lower electrode layer, both a metal electrode formed of platinum (Pr) or iridium (Ir), and a metal oxide electrode formed of a metal oxide such as IrO₂ or RuO₂ are used.

However, the metal oxide electrode is formed at high temperature and high cost. Due to this processing problem, the metal oxide electrode cannot be manufactured on mass scale.

On the other hand, when the SBT film is used as the ferroelectric thin film, the fatigue characteristic is good. However, a desired ferroelectric characteristic is ensured only when formation of the thin film is performed at high temperature. Also, in manufacturing a highly integrated memory device by a poly-plug process, polysilicon of a connect portion between an active region of the memory and a lower electrode on which the ferrorelectric film is to be grown is oxidized as the SBT thin film is crystallized at high temperature. As a result, due to the problem of contact resistance, the electronic device operates incorrectly.

### SUMMARY OF THE INVENTION

To solve the above-described problems, it is a feature of the present invention to provide bismuth lanthanum titanate (BLT) which can be used to form a ferroelectric thin film having a low crystallization temperature and improved fatigue characteristic, a BLT thin film, and methods for preparing the BLT and forming the BLT thin film.

It is another feature of the present invention to provide an electronic device whose fatigue characteristic is improved by adopting the BLT thin film.

In accordance with one aspect of the present invention, there is provided a bismuth lanthanum titanate (BLT) having formula (1):

Bi₄₋ₓLaₓTi₃O₁₂ (1)

where 0<x≦2.

In accordance with another aspect of the present invention, there is provided a method for preparing a bismuth lanthanum titanate (BLT) having formula (1):

Bi₄₋ₓLaₓTi₃O₁₂ (1)

where 0<x≦2, the method comprising the steps of: dissolving a bismuth-containing salt in a first solvent and a second solvent to obtain a bismuth solution; dissolving a lanthanum-containing salt in a third solvent to obtain a lanthanum solution, mixing the lanthanum solution and the bismuth solution to obtain a bismuth lanthanum solution, adding a titanium-containing compound to the bismuth lanthanum solution, and mixing the mixture to obtain a bismuth lanthanum titanium solution; and drying the resultant product of the previous step to remove the solvents, and thermally processing the dried product.

In formula (1), it is preferable that x is in the range of about 0.7-0.75.

In accordance with a further aspect of the present invention, there is provided a bismuth lanthanum titanate (BLT) thin film formed of BLT having formula (1):

Bi₄₋ₓLaₓTi₃O₁₂ (1)

where 0<x≦2. The BLT thin film can be formed by coating a composition for the BLT having formula (1) above on a substrate, and drying and thermally processing the resultant structure. The composition can be prepared by mixing a bismuth solution obtained by dissolving a bismuth-containing salt in a first solvent and a second solvent, a lanthanum solution obtained by dissolving a lanthanum-containing salt in a third solvent, and a titanium-containing compound.

The present invention also provides a method for forming a bismuth lanthanum titanate (BLT) thin film having formula (1):

Bi₄₋ₓLaₓTi₃O₁₂ (1)

where 0<x≦2, the method comprising the steps of: dissolving a bismuth-containing salt in a first solvent and a second solvent to obtain a bismuth solution; dissolving a lanthanum-containing salt in a third solvent to obtain a lanthanum solution, mixing the lanthanum solution and the bismuth solution to obtain a bismuth lanthanum solution, adding a titanium-containing compound to the bismuth lanthanum solution, and mixing the mixture to obtain a bismuth lanthanum titanium solution; and coating the substrate with the bismuth lanthanum titanium solution obtained in the preceding step, and drying and thermally processing the coated product.

In accordance with still another aspect of the present invention, there is provided an electronic device including a BLT thin film as described above. A capacitor can be formed by depositing a conductive layer on and underneath the BLT thin film. In this case, as the conductive layer, a metal electrode formed of at least one selected from the group consisting of Pt, Ru and Ir, or a metal oxide electrode formed of at least one metal oxide selected from the group consisting of IrO₂ and RuO₂, can be used. Although one of the metal electrode and metal oxide electrode is used as the conductive layer, the capacitor has good fatigue characteristic.

In particular embodiments, the electronic device can be a ferroelectric memory device or a pyroelectric sensor.

### BRIEF DESCRIPTION OF THE DRAWINGS

The above features and advantages of the present invention will become more apparent by describing in detail preferred embodiments thereof with reference to the attached drawings in which:

FIG. 1 is a schematic view of the structure of a spin coating apparatus for use in the deposition of a bismuth lanthanum titanate (BLT) thin film according to the present invention;

FIG. 2 shows the X-ray diffraction pattern of BLT thin films formed in Examples 1 through 3 according to the present invention;

FIGS. 3A and 3B are scanning electron microscope (SEM) images (50,000×) of BLT thin films formed in Examples 2 and 3 according to the present invention;

FIGS. 4A and 4B show the P-E characteristic of BLT thin films formed in Examples 2 and 3 according to the present invention;

FIG. 5A shows the fatigue characteristic of a PZT thin film;

FIG. 5B shows the fatigue characteristic of the BLT thin film formed in Example 3 according to the present invention;

FIGS. 6A through 6E are sectional views illustrating a method for manufacturing a preferred embodiment of a memory device according to the present invention; and

FIGS. 7A through 7C are sectional views of another embodiment of the memory device adopting a BLT thin film according to the present invention.

### DETAILED DESCRIPTION OF THE INVENTION

Korean Patent Application No. 00-30796, filed Jun. 5, 2000, and entitled: “LBT Solution, Method for Fabricating LBT Solution and Method for Fabricating LBT Thin Film and Electric Device Using the Same,” is incorporated by reference herein in its entirety.

Bismuth lanthanum titanate (BLT) according to the present invention as a ferroelectric substance is expressed as formula (1), which is obtained by partially substituting bismuth (Bi) atoms of bismuth titanate (Bi₄Ti₃O₁₂) with lanthanum (La) atoms:

Bi₄₋ₓLaₓTi₃O₁₂ (1)

where 0<x≦2.

In formula (1), it is preferable that x is in the range from about 0.7 to about 0.75, and more preferably, about 0.75. This is because the Curie temperature of the ferroelectric BLT at x=0.75 is about 400° C., so that the residual polarization value is very large at 30 μC/cm² (C-axial orientation).

A method for preparing the BLT having formula (1) above will now be described. First, a bismuth containing salt is dissolved in a first solvent and then in a second solvent to obtain a bismuth solution. It is preferable that the bismuth solution is prepared at a temperature of about 60-85° C., and more preferably, about 60-75° C. This is because a uniform bismuth solution can be attained in the range of temperature described above.

Any bismuth-containing salt can be used. Preferably, bismuth acetate, bismuth nitrate, or bismuth acetylacetonate is used. As the first solvent for use in dissolving the bismuth-containing salt, an amine compound can be used. For example, suitable amine compounds include pyridine, triethylamine, trimethylamine, and polyamine. The second solvent, serving as a co-solvent, preferably includes acetic acid, 2-methoxy ethanol, n-propanol, and 2-ethylhexanoic acid. Here, the first and second solvents are mixed in a weight ratio of about 1:15-1:5, and preferably, about 2:15. It is preferable that the total amount of the first and second solvents is in the range of about 2500-2800 parts by weight based on 100 parts by weight of the bismuth-containing salt.

Following this, a lanthanum-containing salt is dissolved in a third solvent and mixed with the bismuth solution to obtain a bismuth lanthanum solution. Any lanthanum-containing salt can be used. Preferably, lanthanum acetate or lanthanum nitrate is used as the lanthanum-containing salt. As the third solvent for use in dissolving the lanthanum-containing salt, acetic acid, 2-methoxyethanol, n-propanol, or 2-ethylhexanoic acid is preferred. It is preferable that the amount of the third solvent is in the range of about 400-500 parts by weight based on 100 parts by weight lanthanum-containing salt. It is preferable that the lanthanum solution is prepared at a temperature of about 60-85° C., and more preferably, about 60-75° C. This is because a uniform lanthanum solution can be attained in the range of temperature described above.

A titanium-containing compound is added into the bismuth lanthanum solution prepared through the above processes, and mixed to obtain a bismuth lanthanum titanium solution. Preferably, the bismuth lanthanum titanium solution is prepared at a temperature of about 60-85° C., and more preferably, about 60-75° C., as in the preparation of the bismuth and lanthanum solutions. The bismuth lanthanum titanium solution can be cooled down to room temperature and filtered to remove impurities, as needed. A higher purity bismuth lanthanum titanate (BLT) is advantageously obtained through the filtration.

As the titanium containing compound, titanium(di-isopropoxide)bis (acetylacetonate) or titanium isopropoxide preferably is used.

Following this, the resultant product is dried to remove the first, second, and third solvents, and a thermal process is performed to obtain BLT. It is preferable that the drying process is performed at a temperature of about 250-600° C. If the drying temperature is less than about 250° C., the solvent in the thin film cannot evaporate completely. It is preferable that the thermal process is performed at a temperature of about 600-750° C. If the temperature of the thermal process is less than about 600° C., the electric characteristic is poor. If the temperature of the thermal process is above about 750° C., it is undesirable for the manufacture of memory.

In the preparation of BLT having formula (1) above, the lanthanum-containing salt preferably is used in an amount of about 0.75 mol based on 3.25 mol bismuth-containing salt. Preferably, the titanium-containing compound is used in an amount of about 3 moles.

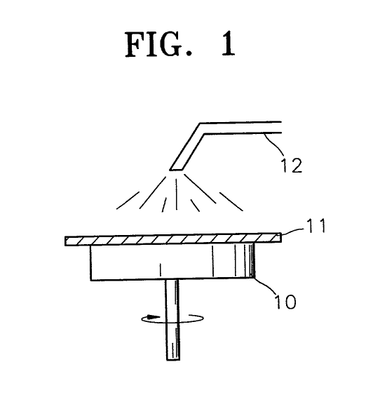

A method for forming a BLT thin film according to the present invention will be described with reference to FIG. 1. Referring to FIG. 1, a substrate 11 is mounted on a rotatable chuck 10 and the chuck 10 is rotated. It is preferable that the rotation speed of the chuck 10 is in the range of about 2000-4000 rpm. A composition for the BLT having formula (1) is applied to the top of the substrate 11 through a supply pipe 12 and spin-coated thereon.

The composition BLT having formula (1) above is prepared, as described above, by mixing the bismuth solution obtained by dissolving a bismuth-containing salt in the first and second solvents, the lanthanum solution obtained by dissolving a lanthanum-containing salt in the second solvent, and a titanium-containing compound. The resultant structure is dried at a temperature of about 250-600° C. Here, the drying time is varied depending on the drying temperature. The drying process is performed within 10 minutes in the range of temperature described above. These procedures are repeatedly conducted to obtain a target film thickness.

After the drying process described above is completed, the substrate is thermally processed at a temperature of about 600-750° C. to form a BLT thin film according to the present invention. Here, the thermal process may be performed by rapid thermal annealing (RTA) or by using a tube furnace in a separate thermal processing chamber equipped with a hot plate. When the thermal process is performed by the RTA, it is preferable that the RTA temperature is in the range of about 650-750° C. If the RTA temperature is less than about 650° C., the ferroelectric characteristic is poor. If the RTA temperature is above about 750° C., it is undesirable for the manufacturing process. When the thermal process is performed using a tube furnace, it is preferable that the thermal process is performed at a temperature of about 600-700° C. If the thermal process using the tube furnace is performed at less than about 600° C., the ferroelectric characteristic is poor. If the thermal process using the tube furnace is performed above about 700° C., it is undesirable for the manufacture of ferroelectric memory.

A capacitor is manufactured by forming a conductive film on and underneath the BLT thin film formed by the above process. Here, as the conductive layer, a metal electrode formed of platinum (Pt), ruthenium (Ru), or iridium (Ir), or a metal oxide electrode formed of IrO₂ or RuO₂, can be used. The metal electrode is preferred as the conductive film because it is easy to manufacture with a high reproducibility and has a better surface roughness characteristic compared to the metal oxide electrode.

A variety of electronic devices, for example, a ferroelectric memory (FeRAM) or pyroelectric sensor, can be manufactured using the capacitor.

The present invention will be described in greater detail by means of the following examples. The following examples are for illustrative purposes and are not intended to limit the scope of the invention.

### EXAMPLE 1

To prepare a 30 ml BLT solution, 3.80 g bismuth acetate was dissolved in 4 ml pyridine, to which 10 ml acetic acid was added. The solution was stirred at about 65° C. to obtain a bismuth solution. Next, 20 ml acetic acid was added to 0.711 g lanthanum acetate, and the mixture was stirred at about 65° C. to obtain a lanthanum solution. The bismuth solution and the lanthanum solution were mixed, 4.24 g titanium(di-isopropoxide)bis(acetylacetonate) was added to the mixture, and the mixture was stirred at 80° C. for about 1 hour. The mixture was cooled down to room temperature and filtered through a 0.2 μm-filter to remove particles from the BLT solution. The filtrate was obtained as a composition for BLT.

The chuck 10 of FIG. 1 was rotated at about 2000 rpm and the composition for BLT was applied onto the surface of the silicon substrate 11 through the supply pipe 12, so that the surface of the silicon substrate 11 was spin-coated with the composition. The resultant structure was dried at 300° C. for 3-5 minutes. The above procedures were conducted to obtain a target film thickness. The resultant structure was moved into a thermal processing chamber equipped with a hot plate to thermally process the resultant structure using a tube furnace at about 600° C. for 30 minutes, thereby resulting in a BLT thin film on the silicon substrate 11.

### EXAMPLE 2

A BLT thin film was formed in the same manner as in Example 1, except that the thermal process was performed at a temperature of 650° C.

### EXAMPLE 3

A BLT thin film was formed in the same manner as in Example 1, except that the thermal process was performed at a temperature of 700° C.

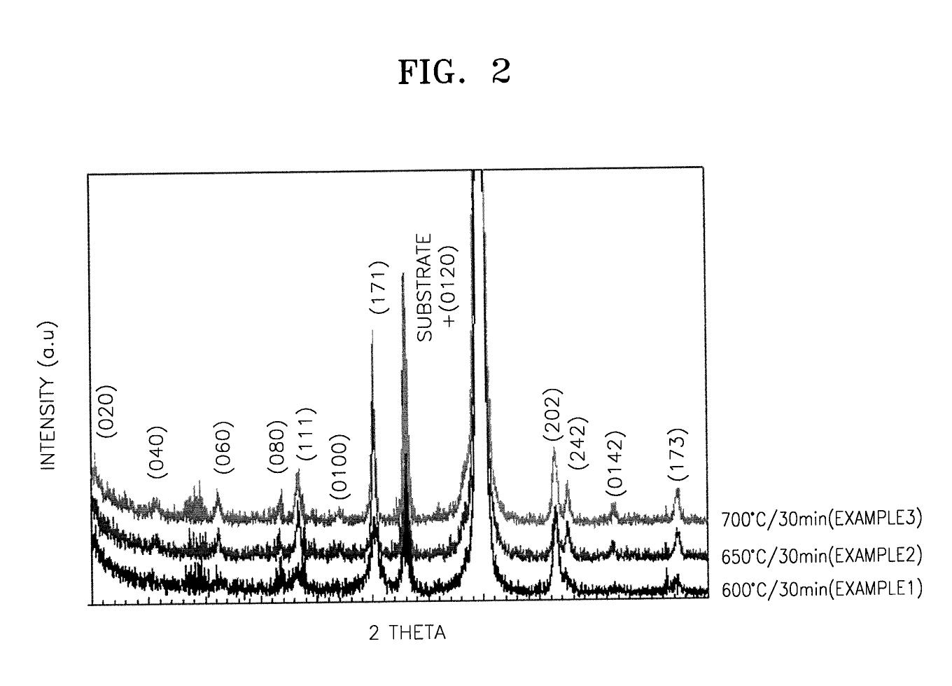

X-ray diffraction pattern analysis was performed for the BLT thin films formed in Examples 1 through 3. The result is shown in FIG. 2. As shown in FIG. 2, it is apparent that BLT crystals are formed in the range of temperature applied in the examples.

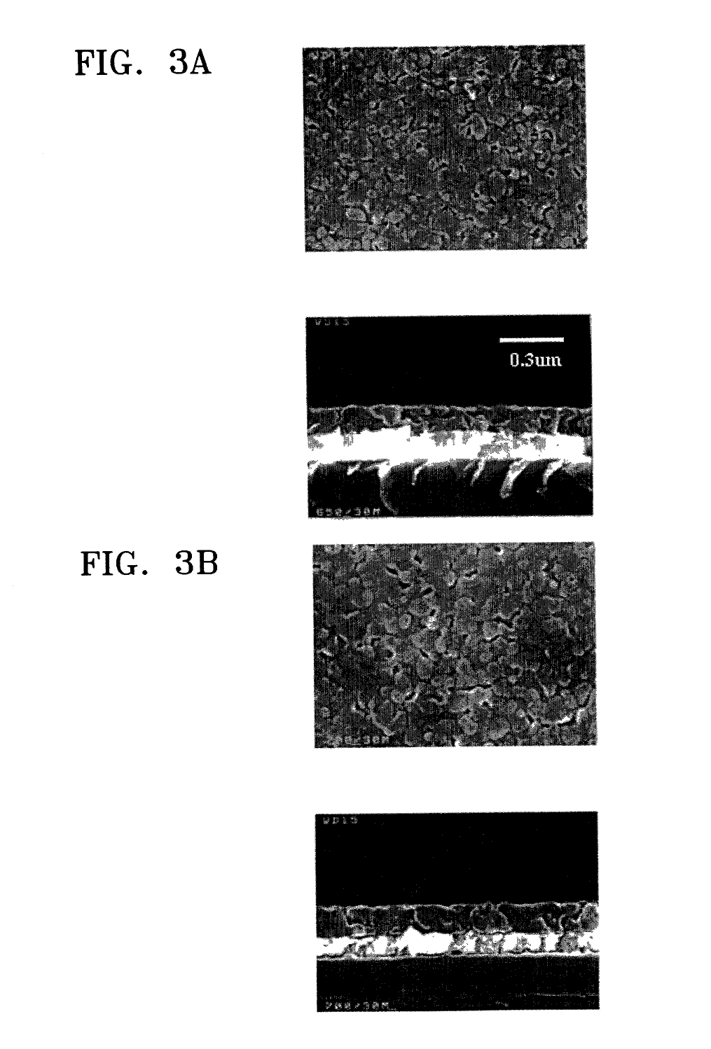

Meanwhile, the cross-sections of the BLT thin films formed in Example 2 and 3 were observed. The results are shown in FIGS. 3A and 3B. FIGS. 3A and 3B are scanning electron microscope (SEM) images (50,000×) of the BLT thin films formed in Examples 2 and 3. For the BLT thin film processed at 650° C. (Example 2), as shown in FIG. 3A, crystal grains appearing as BLT crystals are shown. As shown in FIG. 3B, when the thermal process is performed at 700° C. (Example 3), a BLT thin film including more cavities is formed. In addition, as shown in FIGS. 3A and 3B, the BLT thin films have a thickness of about 0.23 μm and the surface thereof is fairly level. Thus, the BLT thin films according to the present invention are useful in forming a variety of electronic devices in terms of film thickness and surface characteristic.

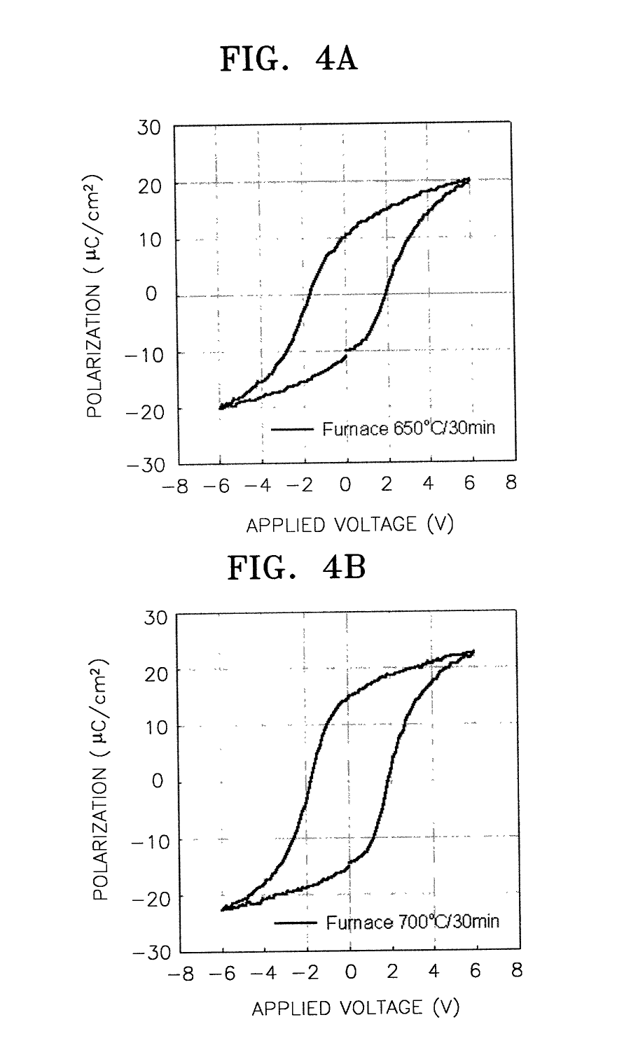

The P-E characteristic was evaluated for the BLT thin films of Examples 2 and 3. The results are shown in FIGS. 4A and 4B. Referring to FIGS. 4A and 4B, both the BLT films of Examples 2 and 3 have a ferroelectric characteristic. It is also apparent that the crystallization of BLT is easier when the thermal process is performed at 650° C. and 700° C. In particular, the residual polarization value (Pr=P*−Pˆ r) of BLT film is larger at 700° C. (FIG. 4B) than at 650° C. (FIG. 4A).

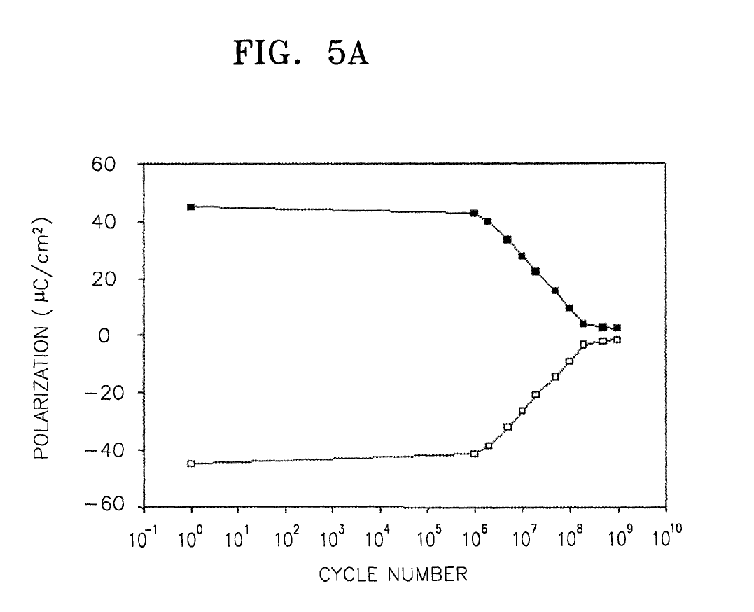

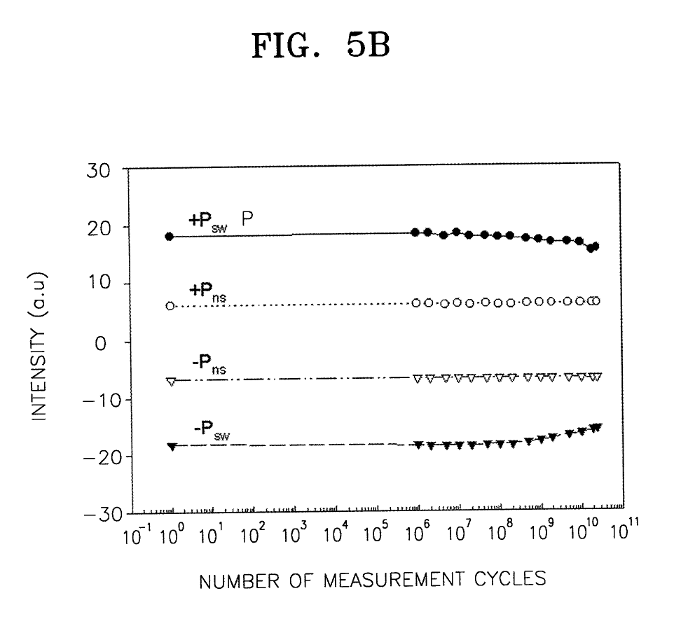

In addition, the fatigue characteristic was measured for the BLT thin film of Example 3. For the fatigue characteristic measurement, a fatigue voltage of 3V at a frequency of 1 MHz was applied, and the amount of polarization of the BLT thin film at 5V was measured. The result of the fatigue characteristic measurement is shown in FIG. 5B.

Referring to FIG. 5B, the variation in the amount of both switching (P_{sw}) and non-switching polarization (Pₙₛ) is very small with increased number of measurement cycles. Also, the variation in the difference between these two values does not become greater with increased number of measurement cycles. When the number of the measurement cycles is greater than 2.5×10¹⁰, the variation in the amount of polarization is small at about less than 10%. Thus, it is evidenced that the fatigue characteristic of the BLT thin film is much better than that of a PZT thin film shown in FIG. 5A.

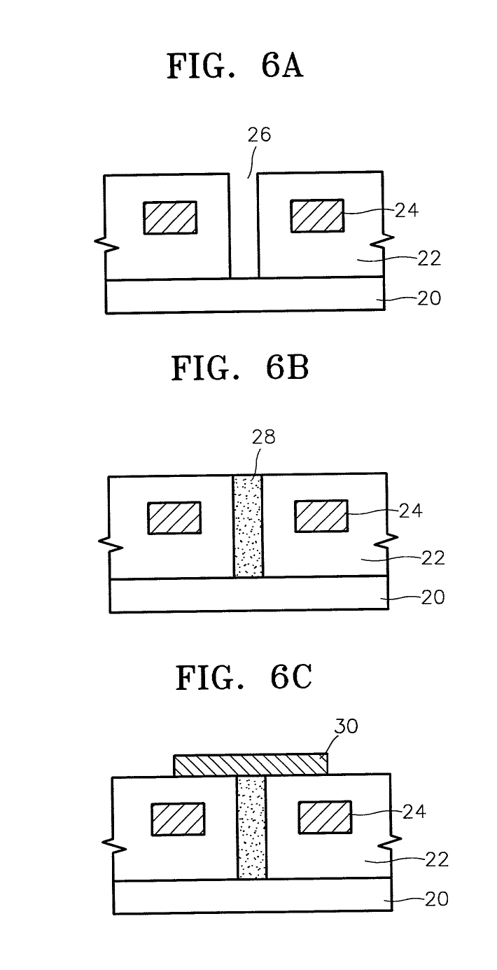

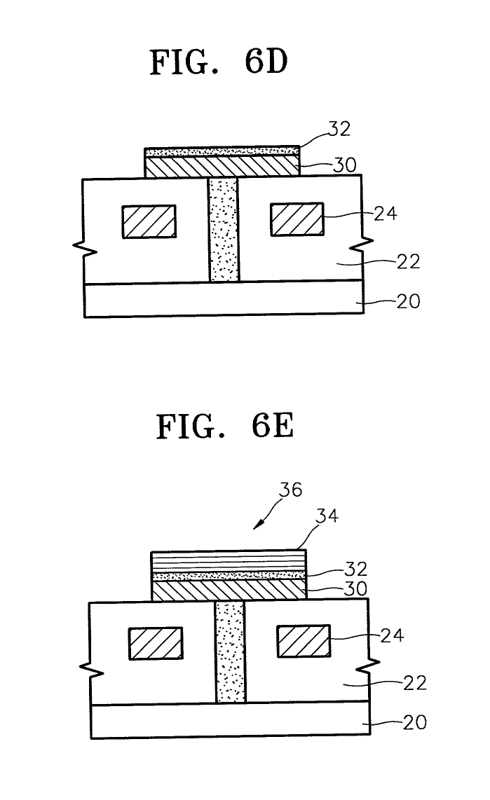

FIGS. 6A through 6E are sectional views illustrating a preferred embodiment of a ferroelectric memory device fabricating method using a BLT thin film according to the present invention. FIG. 6A shows the step of forming a contact hole 26 in a substructure 22 formed on silicon substrate 20. Referring to FIG. 6A, the contact hole 26 is formed by photolithography in the substructure 22 having constituent elements such as a bit line 24.

FIG. 6B shows the step of forming a node of a capacitor on the substructure 22 formed on the silicon substrate 20. Referring to FIG. 6B, a polysilicon layer 28 is deposited on the silicon substrate 20 to fill the contact hole 26. The polysilicon layer 28 is etched such that the polysilicon layer 28 remains only in the contact hole 26, so that the node of the capacitor is completed.

FIG. 6C shows the step of forming a lower electrode 30. An iridium oxide film is deposited on the substructure 22 and the lower electrode 30 is formed by photolithography. Here, platinum (Pt) is formed as a material of the lower electrode 30.

FIG. 6D shows the step of forming a dielectric film on the lower electrode 30. The silicon substrate 20 is mounted on the rotatable chuck 10, as shown in FIG. 1. The composition for BLT is applied on the top of the silicon substrate through the supply pipe 12 while rotating the chuck 10. The resultant structure is dried and thermally processed to form a BLT thin film 32. In particular, the composition for BLT coated on the substructure 22 formed on silicon substrate 20 is dried at a temperature of 250-400° C. for 3-6 minutes, and the resultant silicon substrate is transferred into a thermal processing chamber equipped with a hot plate and processed by RTA, so that the BLT thin film 32 is formed.

FIG. 6E shows the step of forming an upper electrode 34 on the BLT thin film 32. A conductive material such as Pt is deposited on the BLT thin film 32 to form the upper electrode 34, so that a capacitor 36 is completed.

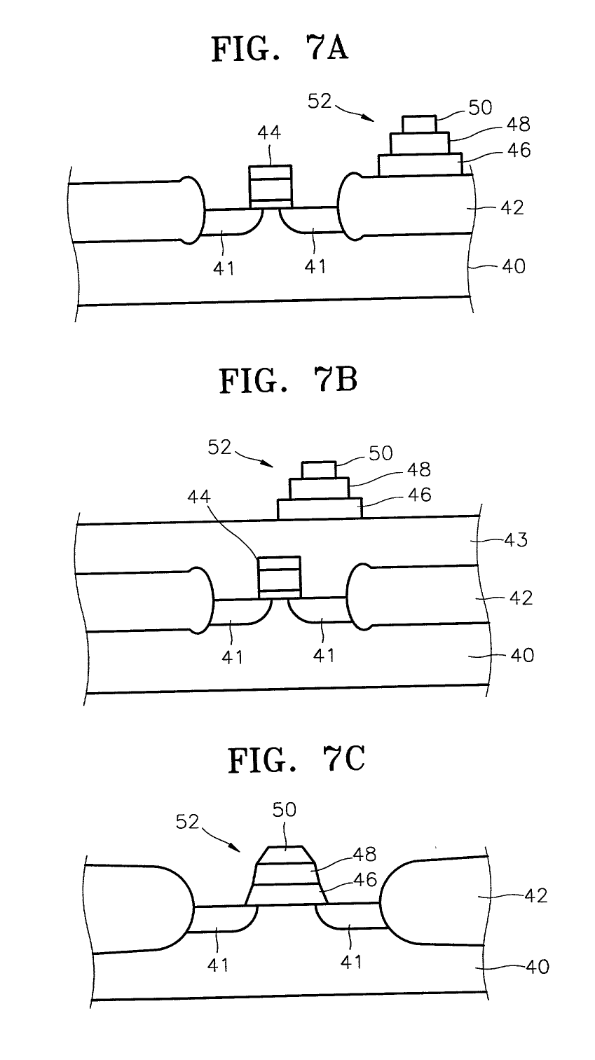

FIGS. 7A through 7C are sectional views illustrating the structure of other memory devices employing the BLT thin film according to the present invention. In particular, FIG. 7A shows the structure of a single transistor memory device using a BLT thin film according to the present invention. FIG. 7B shows the structure of a one-transistor and one-capacitor (1Tr-1C) memory device using a BLT thin film according to the present invention. FIG. 7C shows the structure of a COB (Capacitor-On-Bit line) type 1Tr-1C memory using a BLT thin film according to the present invention.

In FIGS. 7A through 7C, reference numeral 40 represents a silicon substrate, reference numeral 41 represents an active region, reference numeral 42 represents a non-active region, reference numeral 43 represents a substructure, reference numeral 44 represents a gate, reference numeral 45 represents a polysilicon layer, reference numeral 46 represents a lower electrode, reference numeral 48 represents a BLT thin film, reference numeral 50 represents an upper electrode, and reference numeral 52 represents a capacitor. From the ferroelectric memory devices shown in FIGS. 7A through 7C, it is evidenced that a reliable electronic device which exhibits a good fatigue characteristic can be manufactured using only a Pt electrode in forming the lower electrode 46 without the need for an IrO₂ electrode.

Although the embodiments of FIGS. 7A through 7C are illustrated with reference to a high-capacitance ferroelectric memory device, the present invention is applicable to any electronic device using a ferroelectric material.

The ferroelectric BLT having formula (1) above according to the present invention can be processed into a thin film. Although only a metal oxide electrode or metal electrode is used alone as a conductive layer formed on and underneath the BLT thin film, a reliable high-capacitance capacitor which exhibits a good fatigue characteristic can be manufactured. This capacitor can be applied to form an electronic device such as a ferroelectric memory device or pyroelectric sensor.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A bismuth lanthanum titanate (BLT) having formula (1):
Bi₄₋ₓLaₓTi₃O₁₂ (1)
where 0<x≦2.

2. The bismuth lanthanum titanate (BLT) of claim 1, wherein x is in the range of about 0.7-0.75.

3. A method for preparing a bismuth lanthanum titanate (BLT) having formula (1):
Bi₄₋ₓLaₓTi₃O₁₂ (1)
where 0<x≦2, the method comprising the steps of:
(a) dissolving a bismuth-containing salt in a first solvent and a second solvent to obtain a bismuth solution;
(b) dissolving a lanthanum-containing salt in a third solvent to obtain a lanthanum solution;
(c) mixing the lanthanum solution and the bismuth solution to obtain a bismuth lanthanum solution;
(d) adding a titanium-containing compound to the bismuth lanthanum solution and mixing the resulting mixture to obtain a bismuth lanthanum titanium solution; and
(e) drying the solution obtained in step (d) to remove the solvents and thermally processing the dried product.

4. The method of claim 3, wherein the bismuth-containing salt is at least one selected from the group consisting of bismuth acetate, bismuth nitrate, and bismuth acetylacetonate, the lanthanum-containing salt is at least one selected from the group consisting of lanthanum acetate and lanthanum nitrate, and the titanium-containing compound is at least one selected from the group consisting of titanium(di-isopropoxide)bis(acetylacetonate) and titanium isopropoxide.

5. The method of claim 3, wherein the first solvent is an amine compound, and each of the second and third solvents is at least one selected from the group consisting of acetic acid, n-propanol, 2-methoxyethanol, and 2-ethylhexanoic acid.

6. The method of claim 5, wherein the amine compound is selected from the group consisting of pyridine, triethylamine, trimethylamine, and polyamine.

7. The method of claim 3, wherein the drying of step (e) is performed at a temperature of about 250-600° C., and the thermal processing of step (e) is performed at a temperature of about 600-750° C.

8. The method of claim 3, wherein the bismuth solution, the bismuth lanthanum solution and the bismuth lanthanum titanium solution are each prepared at a temperature of about 60-85° C.

9. A bismuth lanthanum titanate (BLT) thin film formed of BLT having the formula (1):
Bi₄₋ₓLaₓTi₃O₁₂ (1)
where 0<x≦2.

10. A method for forming a bismuth lanthanum titanate (BLT) thin film having the formula (1):
Bi₄₋ₓLaₓTi₃O₁₂ (1)
where 0<x≦2, the method comprising the steps of:
(a) dissolving a bismuth-containing salt in a first solvent and a second solvent to obtain a bismuth solution;
(b) dissolving a lanthanum-containing salt in a third solvent to obtain a lanthanum solution;
(c) mixing the lanthanum solution and the bismuth solution to obtain a bismuth lanthanum solution;
(d) adding a titanium-containing compound to the bismuth lanthanum solution and mixing the resulting mixture to obtain a bismuth lanthanum titanium solution;
(e) coating a substrate with the bismuth lanthanum titanium solution; and
(f) drying and thermally processing the bismuth lanthanum titanium solution coated on the substrate.

11. The method of claim 10, wherein the bismuth-containing salt is at least one selected from the group consisting of bismuth acetate, bismuth nitrate, and bismuth acetylacetonate, the lanthanum-containing salt is at least one selected from the group consisting of lanthanum acetate and lanthanum nitrate, and the titanium-containing compound is at least one selected from the group consisting of titanium(di-isopropoxide)bis(acetylacetonate) and titanium isopropoxide.

12. The method of claim 10, wherein the first solvent is an amine compound, and each of the second and third solvents is at least one selected from the group consisting of acetic acid, n-propanol, 2-methoxyethanol, and 2-ethylhexanoic acid.

13. The method of claim 10, wherein the amine compound is selected from the group consisting of pyridine, triethylamine, trimethylamine, and polyamine.

14. The method of claim 10, wherein the drying is performed at a temperature of about 250-600° C., and the thermal processing is performed at a temperature of about 600-750° C.

15. The method of claim 10, wherein the thermal process is performed by rapid thermal annealing (RTA) or by using a tube furnace.

16. An electronic device comprising a bismuth lanthanum titanate (BLT) thin film, the BLT having the formula (1):
Bi₄₋ₓLaₓTi₃O₁₂ (1)
where 0<x≦2.

17. The electronic device of claim 16, comprising a capacitor formed by depositing a conductive layer on and underneath the bismuth lanthanum titanate (BLT) thin film.

18. The electronic device of claim 17, wherein the conductive layer is a metal oxide electrode formed of at least one metal oxide selected from the group consisting of IrO₂ and RuO₂, or a metal electrode formed of at least one selected from the group consisting of Pt, Ru, and Ir.

19. The electronic device of claim 16, wherein the electronic device is a ferroelectric memory device or a pyroelectric sensor.
